(19) United States
(12) Patent Application Publication
(10) Pub. No.: US 2023/0360409 A1
(43) Pub. Date: Nov. 9, 2023

(54) System and Method for License Plate Recognition

(71) Applicant: BOVIA CO., LTD., Hsinchu County (TW)

(72) Inventors: Wei-Jing Yang, Taichung City (TW); Pin-Ta Huang, Taichung City (TW)

(73) Assignee: BOVIA CO., LTD., Hsinchu County (TW)

(21) Appl. No.: 17/842,754

(22) Filed: Jun. 16, 2022

(30) Foreign Application Priority Data
May 4, 2022 (TW) 111116841

(51) Int. Cl. G06V 20/62; G06V 30/16

(52) U.S. Cl. CPC G06V 20/625; G06V 30/1607

(57) ABSTRACT

A license plate recognition system comprises an image capturing unit, for capturing an image; a license plate recognition unit, coupled to the image capture unit, for detecting a location of a license plate image in the image, correcting the license plate image according to at least one first corner of the license plate image, to generate a corrected license plate image, and recognizing the corrected license plate image, to generate a license plate recognition result; and an output unit, coupled to the license plate recognition unit, for outputting the license plate recognition result.

### BACKGROUND OF THE INVENTION

### 1. Field of the Invention

The present invention relates to an image processing, and more particularly, to a system and a method for a license plate recognition.

### 2. Description of the Prior Art

For an application of image processing, a license plate recognition technology has been widely known. However, in practical application scenarios, a license plate image may have inconspicuous license plate features, a license plate distortion, a license plate deformation, a license plate contamination and a light noise due to light source, day and night, climate (e.g., cloudy days and rainy days) and other environmental interference, and a wrong license plate number is recognized. In addition, the license plate image may not be clearly captured due to an obscured license plate, a limited angle of shooting and directions of changing traffic flow, which causes the above situations, and an accuracy of a license plate recognition is reduced. Thus, how to improve the accuracy of the license plate recognition is an important problem to be solved.

### SUMMARY OF THE INVENTION

The present invention therefore provides a system and method for a license plate recognition to solve the abovementioned problem.

A license plate recognition system comprises an image capturing unit, for capturing an image; a license plate recognition unit, coupled to the image capture unit, for detecting a location of a license plate image in the image, correcting the license plate image according to at least one first corner of the license plate image, to generate a corrected license plate image, and recognizing the corrected license plate image, to generate a license plate recognition result; and an output unit, coupled to the license plate recognition unit, for outputting the license plate recognition result.

A method for a license plate recognition comprises capturing an image; detecting a location of a license plate image in the image; correcting the license plate image according to at least one first corner of the license plate image, to generate a corrected license plate image; recognizing the corrected license plate image, to generate a license plate recognition result; and outputting the license plate recognition result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a license plate recognition system according to an example of the present invention.

FIG. 2 is a schematic diagram of a license plate recognition unit according to an example of the present invention.

FIG. 3 is a schematic diagram of a license plate image according to an example of the present invention.

FIG. 4 is a schematic diagram of a transformed license plate image according to an example of the present invention.

FIG. 5 is a flowchart of a process according to an example of the present invention.

FIG. 6 is a flowchart of a process according to an example of the present invention.

FIG. 7 is a flowchart of a process according to an example of the present invention.

FIG. 8 is a flowchart of a process according to an example of the present invention.

### DETAILED DESCRIPTION

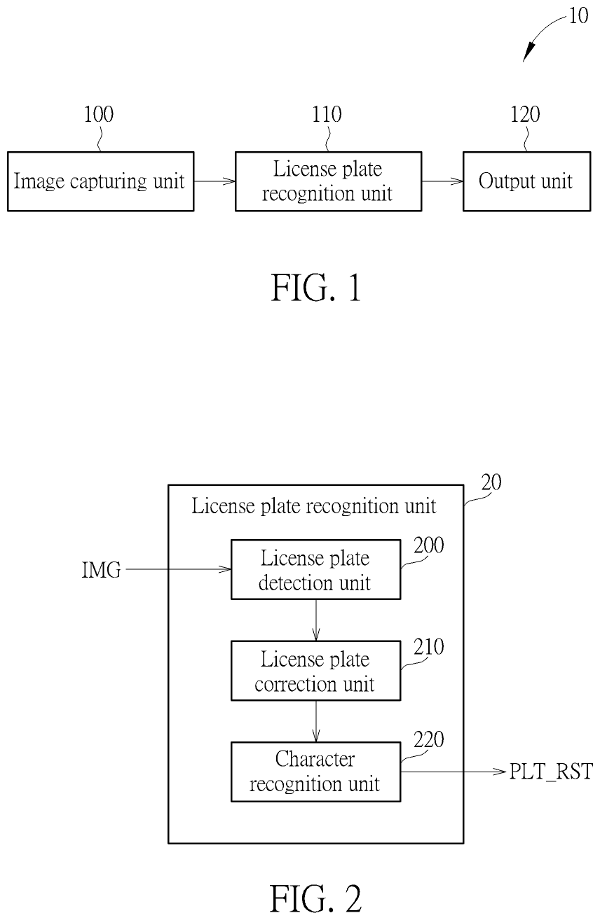

FIG. 1 is a schematic diagram of a license plate recognition system 10 according to an example of the present invention. The license plate recognition system 10 comprises an image capturing unit 100, a license plate recognition unit 110 and an output unit 120. In detail, the image capturing unit 100 is for capturing an image. The image capturing unit 100 is arranged in a monitor, a video camera, a camera, a driving recorder or any of the above combinations, but is not limited herein. The license plate recognition unit 110 is coupled to the image capture unit, and is for detecting a location of a license plate image in the image, correcting the license plate image according to at least one first corner of the license plate image, to generate a corrected license plate image, and recognizing the corrected license plate image, to generate a license plate recognition result. The output unit 120 is coupled to the license plate recognition unit 110, and is for outputting the license plate recognition result. The license plate recognition system 10 may recognize a license plate more accurately via a license plate correction and a character recognition processing, to reduce an error rate of the license plate recognition.

FIG. 2 is a schematic diagram of a license plate recognition unit 20 according to an example of the present invention. The license plate recognition unit 20 may be applied to realize the license plate recognition unit 110 in FIG. 1, but is not limited herein. The license plate recognition unit 20 comprises a license plate detection unit 200, a license plate correction unit 210 and a character recognition unit 220. In detail, the license plate detection unit 200 is coupled to the image capture unit 100 in FIG. 1, and is for receiving an image IMG and detecting the license plate image in the image IMG. The license plate correction unit 210 is coupled to the license plate detection unit 200, and is for detecting the at least one first corner, to generate a transformed license plate image, and detecting at least one second corner of the transformed license plate image, to generate the corrected license plate image. The character recognition unit 220 is coupled to the license plate correction unit 210, and is for recognizing at least one first character in the corrected license plate image and correcting the at least one first character, to generate a license plate recognition result PLT_RST.

In one example, the license plate detection unit 200, the license plate correction unit 210 and the character recognition unit 220 comprise an object recognition network model. The object recognition network model recognizes a target by collecting a large amount of data, labeling and training (e.g., a deep learning) in advance. The target may be the license plate image, the at least one first corner, the at least one second corner or the at least one first character, but is not limited herein. In one example, the license plate detection unit 200 detects the license plate image via a computation of a Neural Network (NN), and generates a confidence value related to the license plate image. In one example, the license plate detection unit 200 outputs the license plate image to the license plate correction unit 210, when the license plate image satisfies a condition (e.g., an area of the license plate image is greater than a first threshold and/or the confidence value is greater than a second threshold). Otherwise, the license plate detection unit 200 does not output the license plate image (or discards the license plate image).

In one example, the license plate correction unit 210 detects the at least one first corner via a corner detection (e.g., a Moravec corner detection, a Harris corner detection, a Shi-Tomasi corner detection, a Plessey corner detection or any of the above combinations, but not limited herein), and generates at least one confidence value related to the at least one first corner, respectively. In one example, the license plate correction unit 210 performs a corner compensation and a geometric transformation of the license plate image, when a number of the at least one first corner is greater than a third threshold (or there is enough confidence value(s) of the at least one confidence value which is greater than a fourth threshold). That is, the number of the at least one first corner is large enough to infer the remaining corner(s). Taking a rectangular license plate as an example, the license plate correction unit 210 performs the corner compensation according to a parallelogram principle, to obtain (or predict) a compensated corner, when the number of the at least one first corner is equal to 3 (or three confidence values in the at least one confidence value are greater than the fourth threshold). In one example, the license plate correction unit 210 records corner coordinates of the four corners of the license plate image. The license plate correction unit 210 performs the geometric transformation of the license plate image according to the corner coordinates, to generate the transformed license plate image. The corrected license plate image is the transformed license plate image (i.e., the license plate correction unit 210 outputs the transformed license plate image to the character recognition unit 220). In one example, the corrected license plate image is the license plate image, when the number of the at least one first corner is not greater than the third threshold (or there is not enough confidence value (s) of the at least one confidence value which is greater than the fourth threshold). That is, the license plate correction unit 210 directly outputs the license plate image to the character recognition unit 220, when the corner compensation and the geometric transformation cannot be performed.

In one example, the license plate correction unit 210 detects the at least one second corner via the corner detection (e.g., the Moravec corner detection, the Harris corner detection, the Shi-Tomasi corner detection, the Plessey corner detection or any of the above combinations, but not limited herein). In one example, the corrected license plate image is the transformed license plate image (i.e., the license plate correction unit 210 outputs the transformed license plate image to the character recognition unit 220), when an area surrounded by the at least one second corner is similar to (or identical to) a target license plate shape (e.g., a rectangle). In one example, the corrected license plate image is the license plate image (i.e., the license plate correction unit 210 outputs the license plate image to the character recognition unit 220), when the area surrounded by the at least one second corner is not similar to the target license plate shape (e.g., the rectangle). That is, the license plate correction unit 210 comprises a checking mechanism for checking whether the license plate image is corrected (or transformed) successfully (e.g., checking whether the area surrounded by at the at least one second corner is similar to the rectangle). The license plate correction unit 210 outputs the corrected license plate image to the character recognition unit 220, if the correction is successful. The license plate correction unit 210 outputs the license plate image before the correction to the character recognition unit 220, if the correction fails.

Taking the rectangular license plate as an example, there are various methods for defining that the area surrounded by the at least one second corner is similar to (or identical to) the rectangle. In one example, two sets of corresponding sides of the area are respectively parallel to each other. In one example, two sets of the corresponding side lengths of the area are respectively similar or equal. In one example, a set of corresponding sides of the area are parallel to each other, and lengths of the corresponding sides are similar or equal. In one example, angles of four corners of the area are equal to or approximately 90 degrees. In one example, two sets of corresponding angles of the area are respectively similar or equal. In one example, two diagonals of the area bisect each other. In one example, lengths of the two diagonals of the area are similar or equal. It should be noted that lengths are similar means that a difference between the lengths is smaller than a first error value, and angles are similar means that a difference between two angles is smaller than a second error value. The above examples may be applied to define that the area surrounded by the at least one second corner is similar to (or identical to) the rectangle, but are not limited herein.

In one example, the character recognition unit 220 recognizes at least one coordinate of the at least one first character. Then, the character recognition unit 220 determines a character order of the at least one first character according to the at least one coordinate. For example, the at least one first character is arranged from left to right according to a value of X coordinate of the at least one coordinate (e.g., a character with a smallest value is arranged at the leftmost, and so on). That is, the character recognition unit 220 not only recognizes characters in the license plate image, but also recognizes the coordinate of each character. The character recognition unit 220 determines the character order according to the coordinates, to reduce the error rate of the license plate recognition.

In one example, the character recognition unit 220 determines whether the at least one first character satisfies a license plate rule. The license plate rule may be related to the regulations of the region governing the license plate. For example, the number of characters in the license plate is 4-7 according to the Taiwan's license plate regulation. License plate formats are 2-4, 4-2, 2-2, 3-2, 2-3, 3-3 and 3-4. X-Y means X characters before “-” and Y characters after “-”. In the license plate format 4-2, the first 4 characters are numbers, and the last 2 characters are English letters or numbers. In the license plate format 2-4, the first 2 characters are English letters or numbers, and the last 4 characters are numbers. In the license plate format 3-4, the first 3 characters are English letters, and the last 4 characters are numbers. In one example, the character recognition unit 220 outputs the at least one first character, when the at least one first character satisfies the license plate rule. Otherwise, the character recognition unit 220 does not output the at least one first character (or discards the at least one first character).

In one example, the character recognition unit 220 stores the at least one first character in a first list according to a time sequence. The character recognition unit 220 deletes the oldest data in the first list to store new data, when a storage space of the first list is full.

In one example, the character recognition unit 220 stores the license plate recognition result PLT_RST in a second list according to a time sequence, after generating the license plate recognition result PLT_RST. In one example, the character recognition unit 220 deletes the oldest data in the second list to store new data, when a storage space of the second list is full. In one example, the data stored in the second list is at least one second character.

In one example, the character recognition unit 220 determines that the license plate recognition result PLT_RST is the at least one second character, when the at least one first character is similar to the at least one second character. There are various ways to define that the at least one first character is similar to the at least one second character. In one example, the at least one first character and the at least one second character have the same number of the characters, wherein only one character is different. For example, ABC-1234 and ABC-1235. In one example, the at least one first character and the at least one second character have the same number of the characters, wherein two adjacent characters have an opposite character order. For example, ABC-1234 and ABC-1324. In one example, numbers of the characters of the at least one first character and the at least one second character differ by one, wherein one of the at least one first character and the at least one second character comprises all characters of other of the at least one first character and the at least one second character. For example, ABC-1234 and AC-1234. The above examples or any combination of the above examples may be applied to define that the at least one first character is similar to the at least one second character, but are not limited herein.

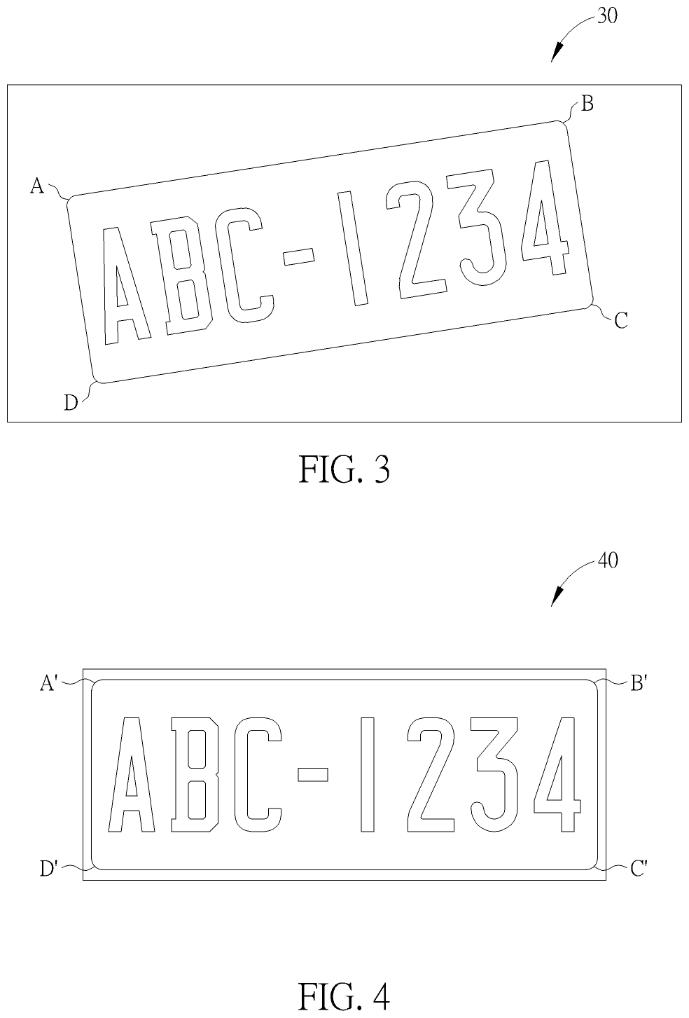

Please refer to FIGS. 3 and 4 simultaneously. FIG. 3 is a schematic diagram of a license plate image 30 according to an example of the present invention. FIG. 4 is a schematic diagram of a transformed license plate image 40 according to an example of the present invention. The license plate image 30 comprises corners A, B, C and D, and the transformed license plate image 40 comprises corners A′, B′, C′ and D′. In one example, a license plate correction unit (e.g., the license plate correction unit 210 in FIG. 2) detects the corners A, B, C and D of the license plate image 30 and records corresponding corner coordinates, after a license plate detection unit (e.g., the license plate detection unit 200 in FIG. 2) detects the license plate image 30. The license plate correction unit performs a geometric transformation of the license plate image 30 according to the recorded corner coordinates, to generate the transformed license plate image 40. In one example, the license plate correction unit detects 3 corners of the license plate image 30 (e.g., the corners A, B and C) and records the corresponding corner coordinates. The license plate correction unit performs a corner compensation according to the 3 detected corners, to obtain a compensated corner (e.g., the corner D) and a compensated corner coordinate. Then, the license plate correction unit performs the geometric transformation of the license plate image 30 according to the recorded corner coordinates and the compensated corner coordinate, to generate the transformed license plate image 40. In one example, the license plate correction unit detects 2 corners of the license plate image 30 (e.g., the corners A and B). The license plate correction unit cannot perform the corner compensation and the geometric transformation, because only two corners are detected Thus, the license plate correction unit directly outputs the license plate image 30 to a character recognition unit (e.g., the character recognition unit 220 in FIG. 2).

In one example, the license plate correction unit detects the corners A′, B′, C′ and D′ of the transformed license plate image 40, and records corresponding corner coordinates. The license plate correction unit outputs the transformed license plate image 40 to the character recognition unit, if an area surrounded by the corners A′, B′, C′ and D′ is similar to (or identical to) a rectangle. The license plate correction unit outputs the license plate image 30 to the character recognition unit, if the area surrounded by the corners A′, B′, C′ and D′ is not similar to the rectangle. In one example, the license plate correction unit detects 3 corners of the transformed license plate image 40 (e.g., the corners A′, B′ and C′), and records the corresponding corner coordinates. The license plate correction unit outputs the license plate image 30 to the character recognition unit, because the area surrounded by the 3 corners is not similar to the rectangle. In one example, the license plate correction unit detects at most 2 corners of the transformed license plate image 40 (e.g., the corners A′ and B′), and records the corresponding corner coordinates. The license plate correction unit outputs the license plate image 30 to the character recognition unit, because the at most 2 corners cannot surround the area.

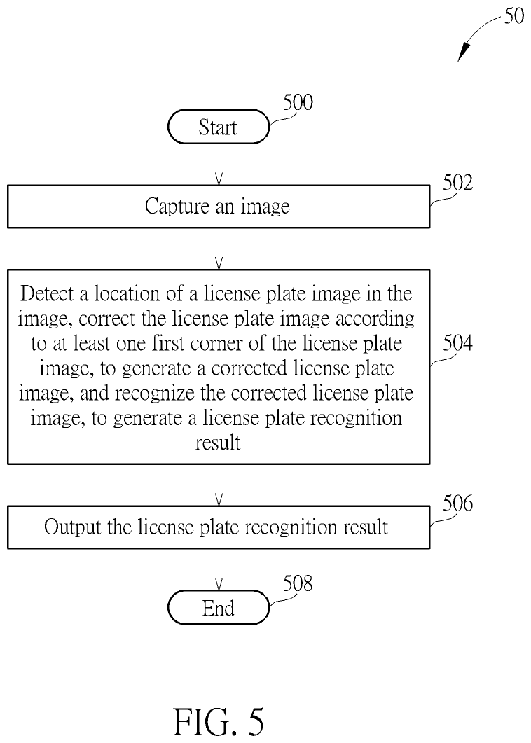

Operations of the license plate recognition system 10 in the above examples can be summarized into a process 50 shown in FIG. 5. The process 50 includes the following steps:

Step 500: Start.

Step 502: Capture an image.

Step 504: Detect a location of a license plate image in the image, correct the license plate image according to at least one first corner of the license plate image, to generate a corrected license plate image, and recognize the corrected license plate image, to generate a license plate recognition result.

Step 506: Output the license plate recognition result.

Step 508: End.

The process 50 is used for illustrating the operations of the license plate recognition system 10. Detailed description and variations of the process 50 can be referred to the previous description, and are not narrated herein.

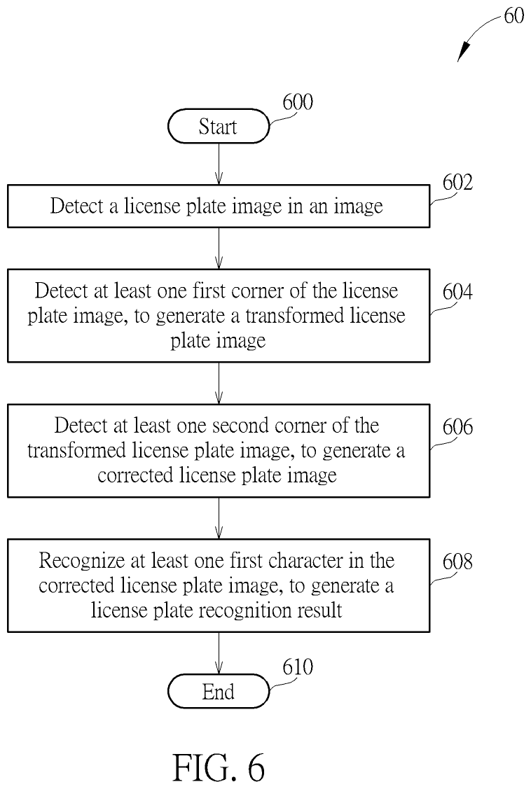

Operations of the license plate recognition units 20 and 110 in the above examples can be summarized into a process 60 shown in FIG. 6. The process 60 includes the following steps:

Step 600: Start.

Step 602: Detect a license plate image in an image.

Step 604: Detect at least one first corner of the license plate image, to generate a transformed license plate image.

Step 606: Detect at least one second corner of the transformed license plate image, to generate a corrected license plate image.

Step 608: Recognize at least one first character in the corrected license plate image, to generate a license plate recognition result.

Step 610: End.

The process 60 is used for illustrating the operations of the license plate recognition units 20 and 110. Detailed description and variations of the process 60 can be referred to the previous description, and are not narrated herein.

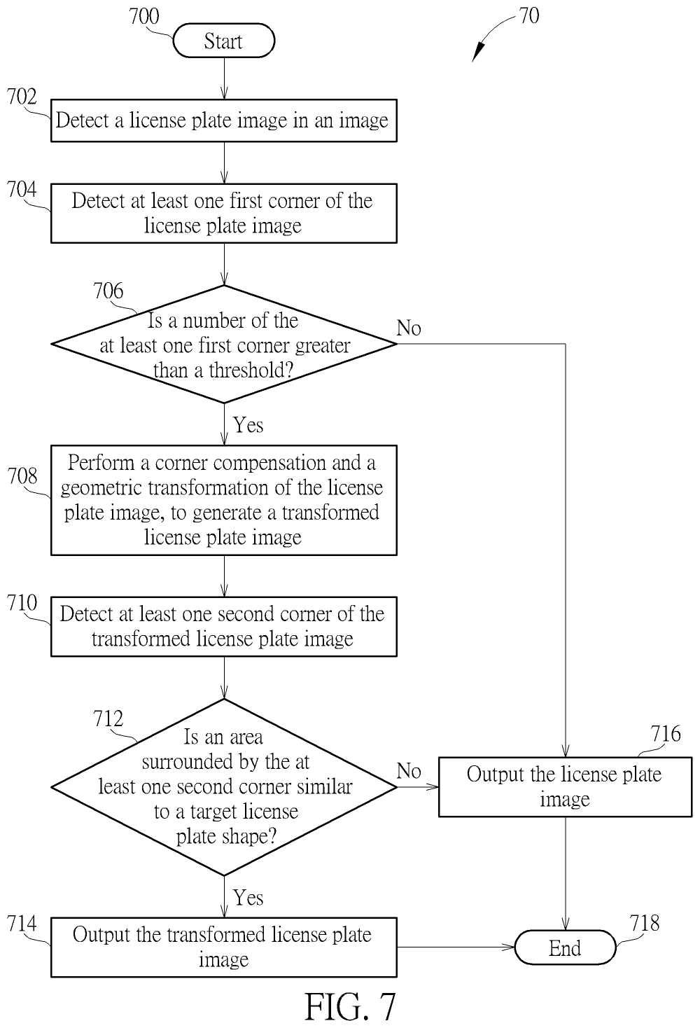

Operations of the license plate detection unit 200 and the license plate correction unit 210 in the above examples can be summarized into a process 70 for the license plate recognition units 20 and 110, shown in FIG. 7. The process 70 includes the following steps:

Step 700: Start.

Step 702: Detect a license plate image in an image.

Step 704: Detect at least one first corner of the license plate image.

Step 706: Is a number of the at least one first corner greater than a threshold? If yes, perform Step 708. If no, perform Step 716.

Step 708: Perform a corner compensation and a geometric transformation of the license plate image, to generate a transformed license plate image.

Step 710: Detect at least one second corner of the transformed license plate image.

Step 712: Is an area surrounded by the at least one second corner similar to a target license plate shape? If yes, perform Step 714. If no, perform Step 716.

Step 714: Output the transformed license plate image, and perform Step 718.

Step 716: Output the license plate image.

Step 718: End.

According to the process 70, the license plate detection unit 200 performs Step 702, and the license plate correction unit 210 performs Steps 704˜716. In one example, Step 706 can be replaced with “Is there enough confidence value(s) of the at least one confidence value related to the at least one first corner which is greater than a threshold”.

The process 70 is used for illustrating the operations of the license plate detection unit 200 and the license plate correction unit 210. Detailed description and variations of the process 70 can be referred to the previous description, and are not narrated herein.

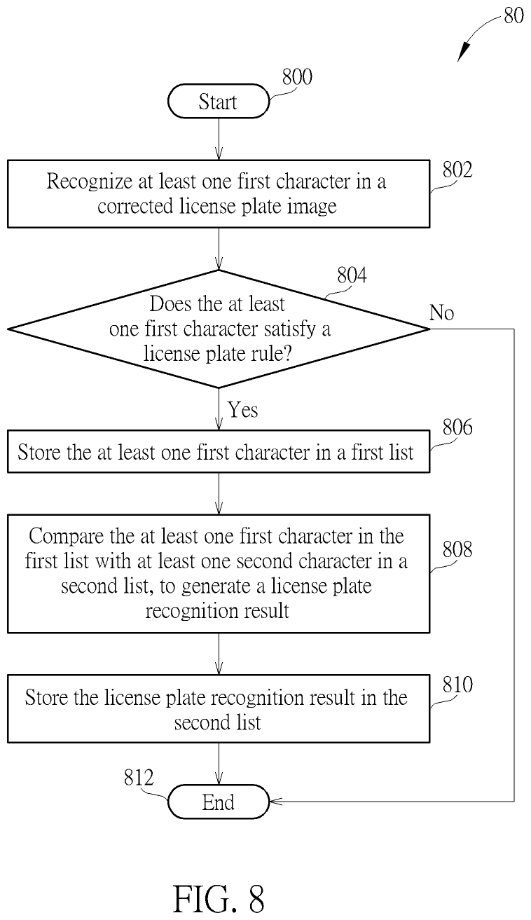

Operations of the character recognition unit 220 in the above examples can be summarized into a process 80 for the license plate recognition units 20 and 110, shown in FIG. 8. The process 80 includes the following steps:

Step 800: Start.

Step 802: Recognize at least one first character in a corrected license plate image.

Step 804: Does the at least one first character satisfy a license plate rule? If yes, perform Step 806. If no, perform Step 812.

Step 806: Store the at least one first character in a first list.

Step 808: Compare the at least one first character in the first list with at least one second character in a second list, to generate a license plate recognition result.

Step 810: Store the license plate recognition result in the second list.

Step 812: End.

The process 80 is used for illustrating the operations of the character recognition unit 220. Detailed description and variations of the process 80 can be referred to the previous description, and are not narrated herein.

It should be noted that there are various realizations of the image capture unit 100, the license plate recognition unit 110, the output unit 120 and the license plate recognition unit 20 (including the license plate detection unit 200, the license plate correction unit 210 and the character recognition unit 220). For example, the devices (circuits) mentioned above may be integrated into one or more devices (circuits). In addition, the image capture unit 100, the license plate recognition unit 110, the output unit 120 and the license plate recognition unit 20 may be realized by hardware (e.g., circuit), software, firmware (known as a combination of a hardware device, computer instructions and data that reside as read-only software on the hardware device), an electronic system or a combination of the devices mentioned above, but is not limited herein.

In the above operations, the operation of “determining” may be replaced by the operation of “computing”, “calculating”, “obtaining”, “generating”, “outputting”, “using”, “choosing/selecting” or “deciding”. In the above operations, the term of “according to” may be replaced by the term of “in response to”. In the above operations, the term of “related to” may be replaced with the term of “of” or “corresponding to”. In the above operations, the term of “via” may be replaced by the term of “on”, “in” or “at”.

To sum up, the present invention provides a system and a method for a license plate recognition. The license plate recognition system performs the geometric transformation according to the corner(s) of the license plate image, to correct the license plate image. In addition, the license plate recognition system checks whether the recognized license plate number is correct according to the license plate numbers stored in the first list and the second list, and corrects the recognized license plate number. Thus, the present invention improves the accuracy of the license plate recognition, to recognize the correct license plate number.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A license plate recognition system, comprising:
an image capturing unit, for capturing an image;
a license plate recognition unit, coupled to the image capture unit, for detecting a location of a license plate image in the image, correcting the license plate image according to at least one first corner of the license plate image, to generate a corrected license plate image, and recognizing the corrected license plate image, to generate a license plate recognition result; and
an output unit, coupled to the license plate recognition unit, for outputting the license plate recognition result.

2. The license plate recognition system of claim 1, wherein the license plate recognition unit comprises:
a license plate detection unit, coupled to the image capture unit, for detecting the license plate image in the image;
a license plate correction unit, coupled to the license plate detection unit, for detecting the at least one first corner, to generate a transformed license plate image, and detecting at least one second corner of the transformed license plate image, to generate the corrected license plate image; and
a character recognition unit, coupled to the license plate correction unit, for recognizing at least one first character in the corrected license plate image.

3. The license plate recognition system of claim 2, wherein the corrected license plate image is the transformed license plate image when an area surrounded by the at least one second corner is similar to a target license plate shape, and the corrected license plate image is the license plate image when the area surrounded by the at least one second corner is not similar to the target license plate shape.

4. The license plate recognition system of claim 2, wherein the character recognition unit recognizes at least one coordinate of the at least one first character, and determines a character order of the at least one first character according to the at least one coordinate.

5. The license plate recognition system of claim 2, wherein the character recognition unit outputs the at least one first character when the at least one first character satisfies a license plate rule, and the character recognition unit does not output the at least one first character when the at least one first character does not satisfy the license plate rule.

6. The license plate recognition system of claim 2, wherein the character recognition unit stores the at least one first character in a first list, and stores the license plate recognition result in a second list.

7. The license plate recognition system of claim 6, wherein the character recognition unit compares the at least one first character in the first list with at least one second character in the second list, to generate the license plate recognition result.

8. The license plate recognition system of claim 1, wherein the license plate recognition unit performs a corner compensation and a geometric transformation of the license plate image when a number of the at least one first corner is greater than a threshold, and the corrected license plate image is the license plate image when the number of the at least one first corner is not greater than the threshold.

9. A method for a license plate recognition, comprising:
capturing an image;
detecting a location of a license plate image in the image;
correcting the license plate image according to at least one first corner of the license plate image, to generate a corrected license plate image;
recognizing the corrected license plate image, to generate a license plate recognition result; and
outputting the license plate recognition result.

10. The method of claim 9, wherein the step of correcting the license plate image according to the at least one first corner of the license plate image, to generate the corrected license plate image comprises:
detecting the license plate image in the image;
detecting the at least one first corner, to generate a transformed license plate image; and
detecting at least one second corner of the transformed license plate image, to generate the corrected license plate image; and
the step of recognizing the corrected license plate image, to generate the license plate recognition result comprises:
recognizing at least one first character in the corrected license plate image.

11. The method of claim 10, wherein the corrected license plate image is the transformed license plate image when an area surrounded by the at least one second corner is similar to a target license plate shape, and the corrected license plate image is the license plate image when the area surrounded by the at least one second corner is not similar to the target license plate shape.

12. The method of claim 10, further comprising:
recognizing at least one coordinate of the at least one first character; and
determining a character order of the at least one first character according to the at least one coordinate.

13. The method of claim 10, further comprising:
outputting the at least one first character, when the at least one first character satisfies a license plate rule; and
not outputting the at least one first character, when the at least one first character does not satisfy the license plate rule.

14. The method of claim 10, further comprising:
storing the at least one first character in a first list; and
storing the license plate recognition result in a second list.

15. The method of claim 14, further comprising:
comparing the at least one first character in the first list with at least one second character in the second list, to generate the license plate recognition result.

16. The method of claim 9, wherein a corner compensation and a geometric transformation of the license plate image are performed when a number of the at least one first corner is greater than a threshold, and the corrected license plate image is the license plate image when the number of the at least one first corner is not greater than the threshold.
